(19) United States
(12) Patent Application Publication
(10) Pub. No.: US 2026/0080258 A1
(43) Pub. Date: Mar. 19, 2026

(54) CONVERSATIONAL ARTIFICIAL INTELLIGENCE AGENT LEARNING METHOD AND DEVICE BASED ON GENERATIVE LANGUAGE MODEL USING CONVERSATIONAL LOG DATA

(71) Applicant: ELECTRONICS AND TELECOMMUNICATIONS RESEARCH INSTITUTE, Daejeon (KR)

(72) Inventor: Yo Han Lee, Daejeon (KR)

(21) Appl. No.: 19/021,823

(22) Filed: Jan. 15, 2025

(30) Foreign Application Priority Data
Sep. 19, 2024 (KR) 10-2024-0126751

(51) Int. Cl. G06N 3/092; G06N 3/0475

(52) U.S. Cl. CPC G06N 3/092; G06N 3/0475

(57) ABSTRACT

A conversational artificial intelligence (AI) agent learning method based on a generative language model includes a step of clustering learning conversation data with respect to a conversation context to generate k number of learning conversation data clusters, a step of learning each of the k learning conversation data clusters to generate k number of generative language models, a step of inputting each learning conversation data cluster to the k generative language models to generate k number of first responses for each learning conversation data cluster, and a step of classifying response preference between the k first responses generated for each learning conversation data cluster to generate (k-1) number of response preference data and automatically generating k×(k-1) number of response preference data corresponding to all of the k learning conversation data clusters without a separate labeling operation.

### CROSS-REFERENCE TO RELATED APPLICATION(S)

This application claims the benefit of the Korean Patent Application No. 10-2024-0126751, filed on Sep. 19, 2024, which is hereby incorporated by reference as if fully set forth herein.

### BACKGROUND

### 1. Field of the Invention

The present disclosure relates to a conversational artificial intelligence (AI) agent learning method, and more particularly, to a method which may learn conversational log data of a user collected in a service process without a separate labeling operation and may measure a reliability level of a compensation model and a device for performing the method.

### 2. Description of Related Art

As conversational artificial intelligence (AI) agents based on a generative language model such as ChatGPT or Gemini are actually used in services, conversational log data of users are being accumulated.

In a case where a generative language model additionally learns conversational log data intactly, a phenomenon occurs where previously learned knowledge is easily forgotten due to catastrophic forgetting which is a chronic problem of an artificial neural network.

Therefore, reinforcement learning from human feedback (RLHF) which is another method for learning conversational log data is attracting much attention.

RLHF is a method where a generative language model outputs various responses in one conversational context and a compensation model, which labels the preference of a person for the responses to assign a response preference score, is learned.

When the compensation model is learned, the generative language model is learned to generate a response for increasing a score of the compensation model. Such a method is applied in learning conversational log data.

In RLHF, a loss function which preserves previous knowledge and increases a score of a compensation model is applied without causing catastrophic forgetting, much time and cost are needed because conversational log data may be additionally learned but a person should construct response preference data so as to learn the compensation model, and a problem where the compensation model is no longer relied occurs when a conversation context of the conversation log data largely differs from a conversation context used in learning of the compensation model.

### PRIOR ART REFERENCE

### Patent Document

Korean Patent Publication No. 10-2023-0119886 (2023.08.16)

### SUMMARY

An aspect of the present disclosure is directed to providing a method, which may automatically construct response preference data and may update a compensation model as conversational log data is accumulated, and thus, may continuously learn a conversational artificial intelligence agent of a service process, and a device for performing the method.

A conversational artificial intelligence (AI) agent learning method based on a generative language model according to embodiments of the present invention includes a step of clustering learning conversation data with respect to a conversation context to generate k number of learning conversation data clusters, a step of learning each of the k learning conversation data clusters to generate k number of generative language models, a step of inputting each learning conversation data cluster to the k generative language models to generate k number of first responses for each learning conversation data cluster, and a step of classifying response preference between the k first responses generated for each learning conversation data cluster to generate (k-1) number of response preference data and automatically generating k×(k-1) number of response preference data corresponding to all of the k learning conversation data clusters without a separate labeling operation, wherein k is a natural number of 2 or more.

In a processor executing a conversational artificial intelligence (AI) agent based on a generative language model according to embodiments of the present invention, as the conversational AI agent is executed, the processor performs a step of clustering learning conversation data with respect to a conversation context to generate k number of learning conversation data clusters, a step of learning each of the k learning conversation data clusters to generate k number of generative language models, a step of inputting each learning conversation data cluster to the k generative language models to generate k number of first responses for each learning conversation data cluster, and a step of classifying response preference between the k first responses generated for each learning conversation data cluster to generate (k-1) number of response preference data and automatically generating k×(k-1) number of response preference data corresponding to all of the k learning conversation data clusters without a separate labeling operation, wherein k is a natural number of 2 or more.

A server system according to embodiments of the present invention includes a communication device configured to communicate with a user computer, a memory device configured to store a conversational artificial intelligence (AI) agent based on a generative language model, and a processor configured to execute the conversational AI agent, wherein the processor performs a step of clustering learning conversation data with respect to a conversation context to generate k number of learning conversation data clusters, a step of learning each of the k learning conversation data clusters to generate k number of generative language models, a step of inputting each learning conversation data cluster to the k generative language models to generate k number of first responses for each learning conversation data cluster, and a step of classifying response preference between the k first responses generated for each learning conversation data cluster to generate (k-1) number of response preference data and automatically generating k×(k-1) number of response preference data corresponding to all of the k learning conversation data clusters without a separate labeling operation, wherein k is a natural number of 2 or more.

The processor may further perform a step of receiving conversational log data through the communication device for communicating with the user computer and a step of calculating a distance between conversational log data and each of the k learning conversation data clusters to measure k number of distances.

The processor may further perform a step of inputting the conversation context of the conversational log data to the k generative language models to generate k number of second responses, a step of generating k number of compensations for the k second responses by using a compensation model, and a step of measuring a reliability level of the compensation model corresponding to the conversational log data by using a correlation between the k distances and the k compensations.

The processor may further perform a step of comparing the measured reliability level of the compensation model with a threshold value and a step of learning the conversational log data by using one of the compensation model and the conversational AI agent, based on a result of the comparison.

A method according to embodiments of the present invention may automatically construct data for determining a response preference of a generative language model, may learn conversational log data accumulated while servicing a conversational artificial intelligence agent, without separate cost, and thus, may guarantee a reliability level of the compensation model in learning conversational data and conversational data of another user.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a schematical block diagram of a generative language model-based service system including a server system executing a conversational artificial intelligence (AI) agent based on a generative language model using conversational log data, according to an embodiment of the present invention.

FIG. 2 is a schematical configuration diagram of a conversational AI agent based on a generative language model using conversational log data, according to an embodiment of the present invention.

FIG. 3 is a concept diagram for describing an operation method of a response preference data automatic construction module illustrated in FIG. 2.

FIG. 4 is a concept diagram for describing a method of automatically constructing response preference data by using a response preference data automatic construction module illustrated in FIG. 2.

FIG. 5 is a concept diagram for describing a method of measuring a reliability level of a compensation model by using a service generative language model illustrated in FIG. 2.

FIG. 6 is a concept diagram for describing a method of learning a generative language model with conversational log data by using a conversational AI agent based on a generative language model using conversational log data, according to an embodiment of the present invention.

### DETAILED DESCRIPTION OF THE INVENTION

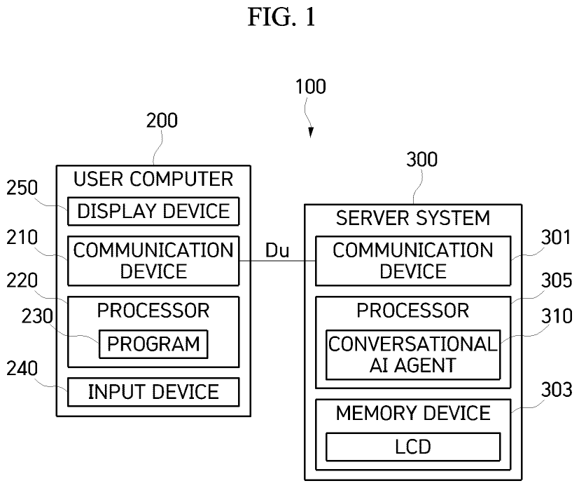

FIG. 1 is a schematical block diagram of a generative language model-based service system 100 including a server system executing a conversational artificial intelligence (AI) agent based on a generative language model using conversational log data, according to an embodiment of the present invention.

The generative language model-based service system 100 may include a user computer 200 and a server system 300.

Conversational log data may denote data which stores a record of a conversation between a user and the server system 300 (for example, chatbot or conversational AI). For example, the conversational log data may include metadata which includes (i) a user input corresponding to a question or a message which is input to the server system 300 by the user who uses the user computer 200, (ii) a system response corresponding to a response provided to the user by the server system 300, (iii) a time stamp corresponding to a time and an order of occurrence of a conversation, (iv) context information which is maintained by the server system 300, based on a flow of a conversation, and (v) additional information such as an identification (ID), a position, device information, and a conversation ID of the user.

The user computer 200 may be a device which has a conversation with the server system 300, and for example, may denote a personal computer (PC) or a mobile device, and the mobile device may denote a laptop computer, a smartphone, or a mobile internet device (MID).

The user computer 200 may include a communication device 210, a processor 220, an input device 240, and a display device 250.

The communication device 210 may perform communication for having a conversation with the communication device 301 of the server system 300 over a wired communication network or a wireless communication network.

A program 230 executed in the processor 220 may control overall operations of the user computer 200 and may control the transmission or reception of a conversation (referred to as a message) with a conversational AI agent 310 which is executed in the processor 305 of the server system 300.

The input device 240 may perform a function of transmitting, to the processor 220, a signal associated with a conversation with the conversational AI agent 310 and may be implemented as a keyboard or a touch screen.

The display device 250 may perform a function of displaying a conversation which is to be transmitted to the server system 300 or a conversation transmitted from the server system 300, based on control by the processor 220 and may be implemented as a monitor or a display. According to embodiments, the display device 250 may be a speaker.

The communication device 301 of the server system 300 may perform a function of receiving a conversation transmitted from the communication device 210 of the user computer 200 to transmit the received conversation to the processor 305 and a function of receiving a conversation transmitted from the processor 305 to transmit the received conversation to the communication device 210 of the user computer 200. Each communication device 210 and 301 may denote a modem or a transceiver.

The conversational AI agent 310 executed in the processor 305 may perform (i) a function of automatically generating (or constructing) response preference data, (ii) a function of measuring a reliability level of a compensation model, and (iii) a function of learning one of a service generative language model and the compensation model, based on the measured reliability level.

The memory device 303 of the server system 300 may perform a function of a data storage device which stores the conversational AI agent 310, data which is to be used by the conversational AI agent 310, and data generated by the conversational AI agent 310.

The conversational AI agent 310 according to embodiments of the present invention may denote a conversation-enabled intelligent agent which transmits or receives a message associated with a character, an image, or a voice to or from a user (for example, a person), based on a generative language model.

The present invention may be for increasing the response quality of the conversational AI agent 310. Herein, therefore, for convenience, the conversational AI agent 310 transmitting or receiving a message of a character type is illustrated or described as an embodiment, but the inventive concept may be applied to a conversational AI agent regardless of an input/output form.

When a conversation context is input based on the generative language model, the conversational AI agent 310 may be trained to output a response suitable for the conversation context. Herein, response preference data for learning the compensation model determining the suitability of a response may be automatically constructed by the conversational AI agent 310 without being directly labeled by a person.

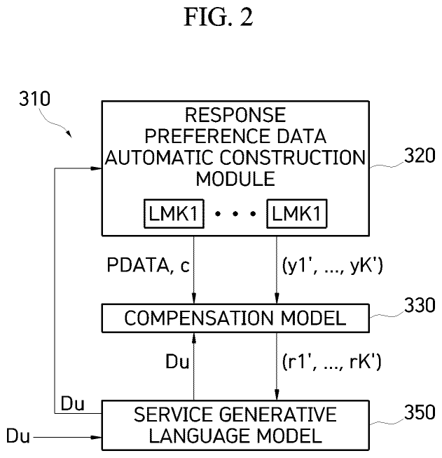

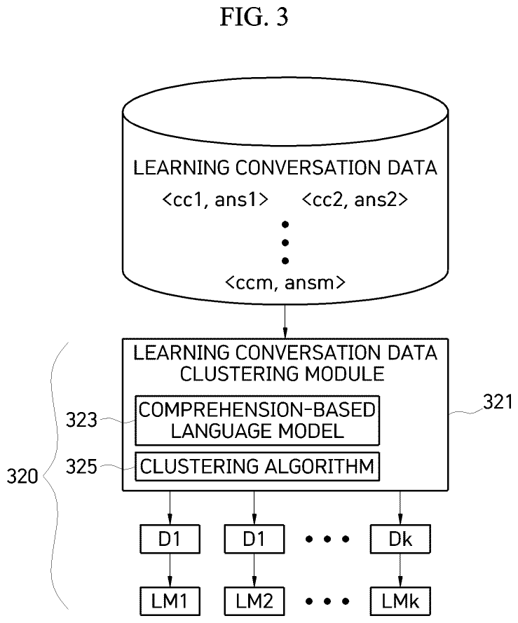

FIG. 2 is a schematical configuration diagram of a conversational AI agent based on a generative language model using conversational log data, according to an embodiment of the present invention. FIG. 3 is a concept diagram for describing an operation method of a response preference data automatic construction module illustrated in FIG. 2.

Referring to FIGS. 1 to 3, the conversational AI agent 310 may include a response preference data automatic construction module 320, a compensation model 330, and a service generative language model 350. The response preference data automatic construction module 320 may be software which configures a portion of the conversational AI agent 310 and may denote a set of program codes capable of performing functions described herein.

A learning conversation data clustering module 321 of the response preference data automatic construction module 320 may cluster learning conversation data LCD including a pair (<cc1, ans1>, <cc2, ans2>, . . . , and <ccm, ansm>) of conversation context (cc1, cc2, . . . , and ccm) and a response (ans1, ans2, . . . , and ansm) with respect to the conversation context (cc1, cc2, . . . , and ccm) to generate k number of learning conversation data clusters D1 to Dk. Here, each of m and k may be a natural number of 2 or more.

The learning conversation data clustering module 321 may input each conversation context (cc1 to ccm) to a comprehension-based language model 323 to obtain a context vector, and then, may apply a clustering algorithm 325 to the context vector to generate the k learning conversation data clusters D1 to Dk.

The comprehension-based language model 323 may be a natural language processing model and may process an input sentence in both directions. The comprehension-based language model 323 may be a bidirectional encoder representation from transformer (BERT), but is not limited thereto.

The clustering algorithm 325 may perform an unsupervised learning method which divides learned conversation data into a plurality of groups (or clusters), based on similar characteristics.

Examples of the clustering algorithm 325 may include a K-means clustering algorithm, a K-medoids clustering algorithm, a hierarchical clustering algorithm, a density-based clustering algorithm, and/or a model-based clustering algorithm, but are not limited thereto.

For example, the learning conversation data clustering module 321 may apply the K-means clustering algorithm to generate k number of clustered learning conversation data D1 to Dk.

Generative language models LM1 to LMk respectively mapped to the learning conversation data clusters D1 to Dk may learn each of the learning conversation data clusters D1 to Dk.

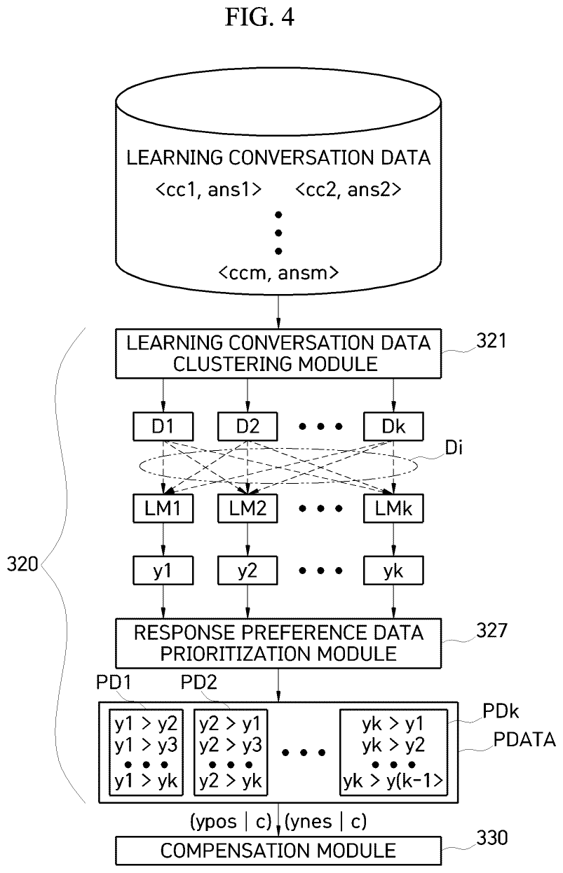

FIG. 4 is a concept diagram for describing a method of automatically constructing response preference data by using the response preference data automatic construction module illustrated in FIG. 2.

Referring to FIGS. 1 to 4, the response preference data automatic construction module 320 may respectively input, to generative language models LM1 to LMk, conversation contexts of a learning conversation data cluster Di (1≤i≤k) selected based on each cluster from among k number of learning conversation data clusters D1 to Dk, and the generative language models LM1 to LMK may respectively generate responses y1 to yk respectively corresponding to the conversation contexts. A conversation context may denote one or more conversation context.

For example, when i is 1 in the selected learning conversation data cluster Di, a conversation context of a first learning conversation data cluster D1 may be input to each of the generative language models LM1 to LMk. A first generative language model LM1 which has learned the first learning conversation data cluster D1 may again learn the first learning conversation data cluster D1.

Therefore, when it is assumed that a first response y1 of the first generative language model LM1 is better than responses y2 to yk of the other generative language models LM2 to LMk, a response preference data prioritization module 327 may classify (referred to as compare) response preference between the other responses y2 to yk with respect to the first response y1 and may generate (k-1) number of response preference data PD1 of the first learning conversation data cluster D1.

In this case, the first response y1 may be a response having high preference, and the responses y2 to yk may be responses having low preference. To provide an additional description, the first response y1 may be a response having first preference, each of the responses y2 to yk may be a response having second preference, and the first preference may be greater than the second preference (y1>y2, y1>y3, . . . , and y1>yk).

As another example, when i is 2 in the selected learning conversation data cluster Di, a conversation context of a second learning conversation data cluster D2 may be input to each of the generative language models LM1 to LMk. A second generative language model LM2 which has learned the second learning conversation data cluster D2 may again learn the second learning conversation data cluster D2.

Therefore, when it is assumed that a second response y2 of the second generative language model LM2 is better than the responses y1 and y3 to yk of the other generative language models LM1 and LM3 to LMk, the response preference data prioritization module 327 may classify response preference between the other responses y1 and y3 to yk with respect to the second response y2 and may generate (k-1) number of response preference data PD2 of the second learning conversation data cluster D2.

In this case, the second response y2 may be a response having high preference, and the responses y1 and y3 to yk may be responses having low preference. To provide an additional description, the second response y2 may be a response having first preference, each of the responses y1 and y3 to yk may be a response having second preference, and the first preference may be greater than the second preference (y2>y1, y2>y3, . . . , and y2>yk).

As another example, when i is k in the selected learning conversation data cluster Di, a conversation context of a k^{th} learning conversation data cluster Dk may be input to each of the generative language models LM1 to LMk. A k^{th} generative language model LMk which has learned the k^{th} learning conversation data cluster Dk may again learn the k^{th} learning conversation data cluster Dk.

Therefore, when it is assumed that a k^{th} response yk of the k^{th} generative language model LMk is better than the responses y1 to y (k-1) of the other generative language models LM1 to LM (k-1), the response preference data prioritization module 327 may classify response preference between the other responses y1 to y (k-1) with respect to the k^{th} response yk and may generate (k-1) number of response preference data PDk of the k^{th} learning conversation data cluster Dk.

In this case, the k^{th} response yk may be a response having high preference, and the responses y1 to y (k-1) may be responses having low preference. To provide an additional description, the k^{th} response yk may be a response having first preference, each of the responses y1 to y (k-1) may be a response having second preference, and the first preference may be greater than the second preference (yk>y1, yk>y2, . . . , yk>y (k-1)).

Based on a method which is the same as or similar to a method of generating (k-1) number of response preference data PD1, PD2, and PDk respectively corresponding to the clustered learning conversation data D1, D2, and Dk, the response preference data prioritization module 327 may generate (k-1) number of response preference data corresponding to each of clustered learning conversation data D3 to D (k-1).

Therefore, where there are k number of learning conversation data clusters D1 to Dk, the response preference data prioritization module 327 may generate (k-1) number of response preference data corresponding to each of the k learning conversation data clusters D1 to Dk, and thus, may automatically generate k×(k-1) number of response preference data PDATA without a separate labeling (or annotation) operation (for example, without feedback from person).

All contexts (cc1 to ccm (referred to as ‘c’)) included in the learning conversation data LCD and the k×(k-1) response preference data PDATA may be used as an input of the compensation model 330 which calculates Equation 1.

When a response having high response preference (or a response having first response preference) is ‘ypos’, and a response having low response preference (or a response having second response preference) is ‘yneg’, the compensation model 330 implemented as a neural network may be trained through an objective function L expressed as Equation 1.

For example, as described above, when the conversation context of the first learning conversation data cluster D1 is input to each of the generative language models LM1 to LMk, the response ypos having high response preference may be the first response y1, and the responses yneg having low response preference may be the other responses y2 to yk.

When the conversation context of the second learning conversation data cluster D2 is input to each of the generative language models LM1 to LMk, the response ypos having high response preference may be the second response y2, and the responses yneg having low response preference may be the other responses y1 and y3 to yk.

When the conversation context of the k^{th} learning conversation data cluster Dk is input to each of the generative language models LM1 to LMk, the response ypos having high response preference may be the k^{th} response yk, and the responses yneg having low response preference may be the other responses y1 to y (k-1).

$$L = E [ log σ ( r ( ypos \vert c ; θ ) - r ( yneg \vert c ; θ ) ) ] \qquad [ Equation 1 ]$$

Here, θ may denote a parameter of the compensation model 330, L may denote a loss function for adjusting the parameter θ, σ may denote a sigmoid function, r may denote compensation (for example, a real number value) which is an output of the compensation model 330, and c may denote all contexts included in the learning conversation data LCD.

The loss function L of Equation 1 may be calculated by converting a value, obtained by applying the sigmoid function σ to a difference between a mean compensation r(ypos|c) of the response ypos having high response preference when the conversation context c is assigned and a mean compensation r(yneg|c) of the responses yneg having low response preference when the conversation context c is assigned, into a log value.

The loss function L may denote a mean of a pair of a response ypos|c having high response preference and a response yneg|c having low response preference when the conversation context c is assigned, in applying an expectation value (′E′ used as an abbreviation of the expectation value) to the calculated log value. For example, an expectation value E [X] may denote a weight mean of values capable of being included in a probability variable X in probability theory.

The loss function L may be for maximizing a probability that a compensation, where the response ypos having high response preference is higher than the response yneg having low response preference, is obtained.

The sigmoid function may convert a difference between the compensation r(ypos|c) of the response ypos having high response preference and the compensation r(yneg|c) of the response yneg having low response preference into a value between 0 and 1, and this may be interpreted as a probability.

The reason that log is applied to such a difference may be for facilitating gradient calculation and enabling stable learning through probabilistic interpretation, in a learning process.

When the contexts c and the parameter θ are assigned, a mean compensation (r (ypos|c; θ) of the response ypos having high response preference may be calculated based on Equation 2, and a mean compensation (r (yneg|c; θ) of the response yneg having low response preference may be calculated based on Equation 3.

$$r ( ypos \vert c ; θ ) = \frac{1}{k * ( k - 1 )} {\sum }_{i = 1}^{k * ( k - 1 )} r ( {y}^{i} pos \vert c ; θ ) \qquad [ Equation 2 ]$$

$$r ( yneg \vert c ; θ ) = \frac{1}{k * ( k - 1 )} {\sum }_{j = 1}^{k * ( k - 1 )} r ( {y}^{i} neg \vert c ; θ ) \qquad [ Equation 3 ]$$

Here, yipos may denote a response ypos having high response preference corresponding to an i^{th} learning conversation data cluster Di among the k learning conversation data clusters D1 to Dk, yjpos may denote a response yneg having low response preference corresponding to a j^{th} learning conversation data cluster Dj among the k learning conversation data clusters D1 to Dk, and i and j may be the same value.

In a function (r (y|c; θ)), the parameter θ may be a value which is adjusted to allow the compensation model 330 to output a compensation for the response y of the conversation context c assigned.

For example, the parameter θ may be a variable which determines a form of the function (r (y|c; θ)). For example, when the compensation model 330 is a neural network, the parameter θ may denote a weight and a bias of the neural network.

The service generative language model 350 may be trained to generate a response for increasing a compensation of the trained compensation model 330 when a conversation context c′ of conversational log data Du is assigned.

The service generative language model 350 may be trained to satisfy the following Equation 4.

$$F = maximize E ( [ r ( y \vert {c}^{′} ; θ ) ] - β K L [ {π}_{φ} ( y \vert {c}^{′} ) ‖ {π}_{0} ( y \vert {c}^{′} ) ] ) \qquad [ Equation 4 ]$$

Here, E may denote an expectation value, r(y|c′; θ) may denote a compensation for the response y generated by the service generative language model 350 which is to be trained when the parameter θ and the conversation context c′ of the conversational log data Du are assigned, β may be a coefficient for adjusting Kullback-Leibler (KL) divergence and may be a predetermined real number, Π_{φ}(y|c′) may denote a probability distribution of the response y generated by the service generative language model 350 which is to be trained when the conversation context c′ of the conversational log data Du is assigned, no (y|c′) may denote a probability distribution of the response y generated by the service generative language model 350 which is to be trained at a learning start time when the conversation context c′ of the conversational log data Du is assigned, and a maximum value F calculated based on Equation 4 may be used for adjusting the probability distribution (Πφ(y|c′)).

The parameter θ may be a final parameter which is adjusted by the compensation model 330, based on Equation 1, and the service generative language model 350 may not adjust the parameter θ.

Kullback-Leibler (KL) divergence may be an example of an asymmetric indicator which measures a difference (i.e., Π_{φ}(y|c′)−Π₀ (y|c′)) between two probability distributions (Π_{φ}(y|c′)) and (Π₀(y|c′)).

According to embodiments, in order to measure the difference (i.e., Π_{φ}(y|c′)−Π₀ (y|c′)) between the two probability distributions (Π_{φ}(y|c′)) and (Π₀(y|c′)), the service generative language model 350 may use Jensen-Shannon (JS) divergence, Relative Entropy divergence, Earth Mover's Distance (EMD) divergence, or Hellinger Distance divergence, in addition to Kullback-Leibler (KL) divergence.

A service process, the service generative language model 350 may learn accumulated conversational log data of a user by applying Equation 4.

However, when a conversation context of learning conversation data learned by the compensation model 330 largely differs from a conversation context of conversational log data, a compensation provided by the compensation model 330 may not be relied, but the service generative language model 350 according to an embodiment of the present invention may include a function which measures a reliability level of the compensation model 330 corresponding to conversational log data and additionally trains the compensation model 330 with the conversational log data when the measured reliability level is low.

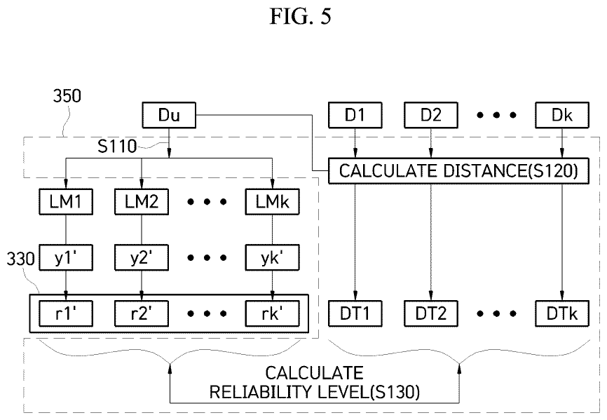

FIG. 5 is a concept diagram for describing a method of measuring a reliability level of a compensation model by using a service generative language model illustrated in FIG. 2.

A method of measuring a reliability level of the compensation model 330 corresponding to the conversational log data Du of a user by using the service generative language model 350 will be described below in detail with reference to FIGS. 1, 2, and 5.

The service generative language model 350 may receive, through the communication device 301, conversational log data Du including a conversation context c′ transmitted through the communication device 210 of the user computer 200 and may transmit the conversational log data Du to the k generative language model LM1 to LMk included in the response preference data automatic construction module 320 in step S110.

In FIGS. 2 to 4, for convenience of description, the k generative language model LM1 to LMk are illustrated as being included in the response preference data automatic construction module 320, but are not limited thereto. According to embodiments, the k generative language model LM1 to LMk may be provided outside the response preference data automatic construction module 320, and in this case, the response preference data automatic construction module 320 and the service generative language model 350 may share or use the k generative language model LM1 to LMk.

The generative language model LM1 to LMk may respectively generate responses y1′ to yk′ of the conversation context c′ of the conversational log data Du and may transmit the responses y1′ to yk′ to the compensation model 330.

The compensation model 330 may calculate or generate compensations r1′ to rk′ (for example, r1′ (=(y′1|c′)) to rk′ (=(yk′|c))) for the conversation context c′ assigned.

The service generative language model 350 may calculate a distance between the conversational log data Du and each of learning conversation data clusters D1 to Dk and may generate each of distances DT1 to DTk (referred to as a distance value). In this case, a first distance DT1 may be a distance between a first learning conversation data cluster D1 and the conversational log data Du, a second distance DT2 may be a distance between a second learning conversation data cluster D2 and the conversational log data Du, and a k^{th} distance DTk may be a distance between a k^{th} learning conversation data cluster Dk and the conversational log data Du.

For example, a comprehension-based language model (for example, BERT) may express the conversational log data Du as a vector, and each of the distances DT1 to DTk may be measured to be a Euclidean distance or a cosine similarity between the expressed vector and a centroid of the learning conversation data clusters D1 to Dk.

The service generative language model 350 may measure a reliability level of the compensation model 330 corresponding to the conversational log data Du by using the distances DT1 to DTk and the compensations r1′ to rk′ (referred to as compensation values) for the compensation model 330.

For example, when it is assumed that the compensations r1′ to rk′ for the responses y1′ to yk′ of the generative language model LM1 to LMk generated from the conversation context c′ of the conversational log data Du have a correlation and a similarity with the conversational log data Du and conversation data learned by each of the generative language model LM1 to LMK, a reliability level of the compensation model 330 corresponding to the conversational log data Du may be measured.

The reliability level of the compensation model 330 may be an indicator representing the degree of accuracy to which the compensation model 330 predicts or evaluates a compensation for a specific situation or input. A reliability level may denote the degree of proximity between a real compensation or a target and a compensation output from the compensation model 330.

The service generative language model 350 may convert a relationship (for example, reliability level) between the compensations r1′ to rk′ for the responses y1′ to yk′ of the generative language model LM1 to LMk and the the distances DT1 to DTk into a spearman correlation or a probability with a softmax function, and then, may calculate and measure a cross entropy between two probability distributions.

An embodiment of a method of measuring a reliability level RL may be expressed as in Equation 5.

$$R L ( {r}^{′} , DT ) = - {\sum }_{i = 1}^{k} {r}_{i}^{′} log {DT}_{i} \qquad [ Equation 5 ]$$

Here, r′ may denote a compensation of the compensation model 330 for the responses y1′ to yk′ of the generative language model LM1 to LMk, and DT may denote a distance between each of the learning conversation data clusters D1 to Dk and the conversational log data Du.

When the conversational log data Du is provided in plurality, a mean of reliability levels RL may be a reliability level of the compensation model 330.

When a reliability level RL is less than a threshold value, the service generative language model 350 may allow the compensation model 330 to additionally learn the conversational log data Du.

A response of a generative language model learned with learning conversation data closest to the conversational log data Du among the learning conversation data clusters D1 to Dk may be set to ypos, and the other responses may be set to yneg, and based thereon, the compensation model 330 may be additionally trained through Equation 1.

For example, when the first learning conversation data cluster D1 is closest to the conversational log data Du, a response of the first generative language model LM1 may be ypos, and responses of the other generative language models LM2 to LMk may be yneg.

When the conversation context c′ of the conversational log data Du is assigned, the compensation model 330 may calculate a loss function L by using the response ypos of the first generative language model LM1 corresponding to the conversation context c′ and the responses yneg of the other generative language models LM2 to LMk, and a parameter θ of the compensation model 330 may be adjusted by the calculated loss function L.

At this time, when a conversation context c of Equation 1 is replaced with the conversation context c′ of the conversational log data Du, a method where the compensation model 330 additionally learns the conversation context c′ of the conversational log data Du may also be understood.

The compensation model 330 may be trained with the conversational log data Du, and thus, the reliability of the conversational log data Du may be guaranteed.

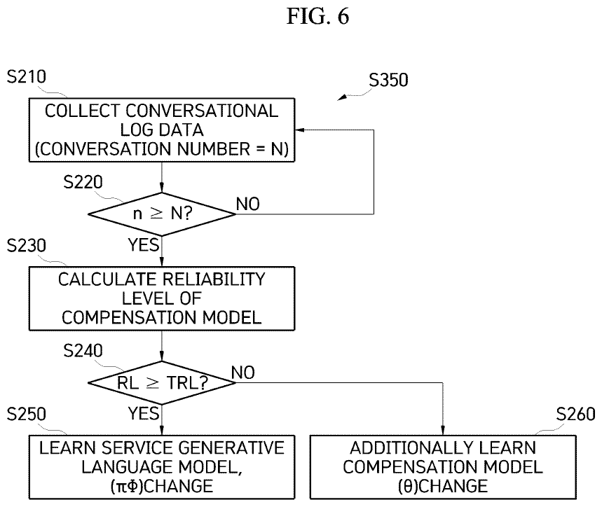

FIG. 6 is a concept diagram for describing a method of learning a generative language model with conversational log data by using a conversational AI agent based on a generative language model using conversational log data, according to an embodiment of the present invention.

Operating methods S350 of the service generative language model 350 may be described with reference to FIGS. 1 to 6.

The service generative language model 350 may collect conversational log data with the user computer 200 in step S210. In this case, when the number of conversations is assumed to be n, the service generative language model 350 may compare a size N of a conversational log buffer with a magnitude of the number of n conversations in step S220, and when the magnitude of the number of n conversations is less than the size N of the conversational log buffer (NO of S220), the service generative language model 350 may stand by until a conversation corresponding to the number of n conversations is stored in the conversational log buffer or a new conversation is input thereto.

For example, the conversational log buffer may be the memory device 303, or may be a separate memory device (for example, random access memory (RAM)) accessible by the processor 305.

The magnitude of the number of n conversations may be represented as a token, a word, or a sentence, or may be represented as a byte unit.

However, when a size corresponding to a conversation number n stored in the conversational log buffer is greater than or equal to a size N of the conversational log buffer (YES of S220), the service generative language model 350 may calculate a reliability level RL of the compensation model in step S230, and the service generative language model 350 may measure a reliability level RL of a conversation context corresponding to the conversation number n by using Equation 5 in step S240.

When the measured reliability level RL is greater than or equal to a threshold value TRL (YES of S240), the service generative language model 350 may learn the conversational log data Du corresponding to the conversation number n and may adjust a probability distribution (Π_{φ}(y|c′)) by using a maximum value F calculated based on Equation 4 in step S250.

However, when the measured reliability level RL is less than the threshold value TRL (NO of S240), the service generative language model 350 may transmit the conversational log data Du, corresponding to the conversation number n, to the compensation model 330.

The compensation model 330 may calculate the loss function L by using Equation 1 and may adjust the parameter θ of the compensation model 330 by using the calculated loss function L in step S260.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A conversational artificial intelligence (AI) agent learning method based on a generative language model, the conversational AI agent learning method comprising:
a step of clustering learning conversation data with respect to a conversation context to generate k number of learning conversation data clusters;
a step of learning each of the k learning conversation data clusters to generate k number of generative language models;
a step of inputting each learning conversation data cluster to the k generative language models to generate k number of first responses for each learning conversation data cluster; and
a step of classifying response preference between the k first responses generated for each learning conversation data cluster to generate (k-1) number of response preference data and automatically generating k×(k-1) number of response preference data corresponding to all of the k learning conversation data clusters without a separate labeling operation,
wherein k is a natural number of 2 or more.

2. The conversational AI agent learning method of claim 1, further comprising a step of calculating a distance between conversational log data and each of the k learning conversation data clusters to measure k number of distances.

3. The conversational AI agent learning method of claim 2, further comprising:
a step of inputting the conversation context of the conversational log data to the k generative language models to generate k number of second responses;
a step of generating k number of compensations for the k second responses by using a compensation model; and
a step of measuring a reliability level of the compensation model corresponding to the conversational log data by using a correlation between the k distances and the k compensations.

4. The conversational AI agent learning method of claim 3, further comprising:
a step of comparing the measured reliability level of the compensation model with a threshold value; and
a step of learning the conversational log data by using one of the compensation model and the conversational AI agent, based on a result of the comparison.

5. The conversational AI agent learning method of claim 4, further comprising:
a step of comparing a size of a conversational log buffer with a magnitude corresponding to a conversation number of the conversational log data;
a step of standing by for receiving a new conversation of the conversational log data, when the magnitude corresponding to the conversation number is less than the size of the conversational log buffer; and
a step of measuring a reliability level of the compensation model by using the correlation between the k distances and the k compensations, when the magnitude corresponding to the conversation number is not less than the size of the conversational log buffer.

6. The conversational AI agent learning method of claim 3, further comprising:
a step of comparing the measured reliability level of the compensation model with a threshold value;
a step of learning the conversational log data by using the compensation model, when the reliability level of the compensation model is less than the threshold value; and
a step of learning the conversational log data by using the conversational AI agent, when the reliability level of the compensation model is not less than the threshold value.

7. The conversational AI agent learning method of claim 3, further comprising:
a step of calculating a difference between a mean compensation of a response having first preference corresponding to a response generated for each generative language model when the conversation context of the learning conversation data is assigned and a mean compensation of a response having second preference corresponding to the response generated for each generative language model when the conversation context of the learning conversation data is assigned;
a step of applying a sigmoid function to the difference to generate a sigmoid value by using the compensation model;
a step of converting the sigmoid value into a log to generate a log value by using the compensation model;
a step of applying an expectation value to the log value to calculate a loss function by using the compensation model; and
a step of adjusting a parameter of the compensation model by using the compensation model, based on the loss function,
wherein the first preference is greater than the second preference.

8. A processor executing a conversational artificial intelligence (AI) agent based on a generative language model,
as the conversational AI agent is executed, the processor performing:
a step of clustering learning conversation data with respect to a conversation context to generate k number of learning conversation data clusters;
a step of learning each of the k learning conversation data clusters to generate k number of generative language models;
a step of inputting each learning conversation data cluster to the k generative language models to generate k number of first responses for each learning conversation data cluster; and
a step of classifying response preference between the k first responses generated for each learning conversation data cluster to generate (k-1) number of response preference data and automatically generating k×(k-1) number of response preference data corresponding to all of the k learning conversation data clusters without a separate labeling operation,
wherein k is a natural number of 2 or more.

9. The processor of claim 8, further performing a step of calculating a distance between conversational log data and each of the k learning conversation data clusters to measure k number of distances.

10. The processor of claim 9, further performing:
a step of inputting the conversation context of the conversational log data to the k generative language models to generate k number of second responses;
a step of generating k number of compensations for the k second responses by using a compensation model; and
a step of measuring a reliability level of the compensation model corresponding to the conversational log data by using a correlation between the k distances and the k compensations.

11. The processor of claim 10, further performing:
a step of comparing the measured reliability level of the compensation model with a threshold value; and
a step of learning the conversational log data by using one of the compensation model and the conversational AI agent, based on a result of the comparison.

12. The processor of claim 11, further performing:
a step of comparing a size of a conversational log buffer with a magnitude corresponding to a conversation number of the conversational log data;
a step of standing by for receiving a new conversation of the conversational log data, when the magnitude corresponding to the conversation number is less than the size of the conversational log buffer; and
a step of measuring a reliability level of the compensation model by using the correlation between the k distances and the k compensations, when the magnitude corresponding to the conversation number is not less than the size of the conversational log buffer.

13. The processor of claim 10, further performing:
a step of comparing the measured reliability level of the compensation model with a threshold value;
a step of learning the conversational log data by using the compensation model, when the reliability level of the compensation model is less than the threshold value; and
a step of learning the conversational log data by using the conversational AI agent, when the reliability level of the compensation model is not less than the threshold value.

14. A server system comprising:
a communication device configured to communicate with a user computer;
a memory device configured to store a conversational artificial intelligence (AI) agent based on a generative language model; and
a processor configured to execute the conversational AI agent,
wherein the processor performs:
a step of clustering learning conversation data with respect to a conversation context to generate k number of learning conversation data clusters;
a step of learning each of the k learning conversation data clusters to generate k number of generative language models;
a step of inputting each learning conversation data cluster to the k generative language models to generate k number of first responses for each learning conversation data cluster; and
a step of classifying response preference between the k first responses generated for each learning conversation data cluster to generate (k-1) number of response preference data and automatically generating k×(k-1) number of response preference data corresponding to all of the k learning conversation data clusters without a separate labeling operation,
wherein k is a natural number of 2 or more.

15. The server system of claim 14, wherein the processor further performs:
a step of receiving conversational log data through the communication device for communicating with the user computer; and
a step of calculating a distance between conversational log data and each of the k learning conversation data clusters to measure k number of distances.

16. The server system of claim 15, wherein the processor further performs:
a step of inputting the conversation context of the conversational log data to the k generative language models to generate k number of second responses;
a step of generating k number of compensations for the k second responses by using a compensation model; and
a step of measuring a reliability level of the compensation model corresponding to the conversational log data by using a correlation between the k distances and the k compensations.

17. The server system of claim 16, wherein the processor further performs:
a step of comparing the measured reliability level of the compensation model with a threshold value; and
a step of learning the conversational log data by using one of the compensation model and the conversational AI agent, based on a result of the comparison.

18. The server system of claim 17, wherein the processor further performs:
a step of comparing a size of a conversational log buffer with a magnitude corresponding to a conversation number of the conversational log data;
a step of standing by for receiving a new conversation of the conversational log data, when the magnitude corresponding to the conversation number is less than the size of the conversational log buffer; and
a step of measuring a reliability level of the compensation model by using the correlation between the k distances and the k compensations, when the magnitude corresponding to the conversation number is not less than the size of the conversational log buffer.

19. The server system of claim 16, wherein the processor further performs:
a step of comparing the measured reliability level of the compensation model with a threshold value;
a step of learning the conversational log data by using the compensation model, when the reliability level of the compensation model is less than the threshold value; and
a step of learning the conversational log data by using the conversational AI agent, when the reliability level of the compensation model is not less than the threshold value.

20. The server system of claim 16, wherein the processor further performs:
a step of calculating a difference between a mean compensation of a response having first preference corresponding to a response generated for each generative language model when the conversation context of the learning conversation data is assigned and a mean compensation of a response having second preference corresponding to the response generated for each generative language model when the conversation context of the learning conversation data is assigned;
a step of applying a sigmoid function to the difference to generate a sigmoid value by using the compensation model;
a step of converting the sigmoid value into a log to generate a log value by using the compensation model;
a step of applying an expectation value to the log value to calculate a loss function by using the compensation model; and
a step of adjusting a parameter of the compensation model by using the compensation model, based on the loss function,
wherein the first preference is greater than the second preference.
